(19) United States
(12) Patent Application Publication
(10) Pub. No.: US 2020/0109731 A1
(43) Pub. Date: Apr. 9, 2020

(54) CORNER BRACKET STRUCTURE

(71) Applicants: Jeanne L. Hall, Flagstaff, AZ (US); Dan Wolken, Siloam Springs, AR (US)

(72) Inventors: Jeanne L. Hall, Flagstaff, AZ (US); Dan Wolken, Siloam Springs, AR (US)

(21) Appl. No.: 16/152,308

(22) Filed: Oct. 4, 2018

(51) Int. Cl. F16B 12/14; F16C 11/10; F16C 11/06; A01K 1/03

(52) U.S. Cl. CPC F16B 12/14; A01K 1/033; F16C 11/0604; F16C 11/10

(57) ABSTRACT

A corner bracket structure for fastening together a pair of panels includes a first elongated member having convex projections extending from one side thereof. A second elongated member has a concave elongated channel extending from one side thereof. The elongated channel includes retaining regions for capturing the projections. The retaining regions are spaced apart from each other by recessed regions that initially receive the projections. The projections are inserted into recessed regions, and slid into the retaining regions to form a semi-hinged connection.

### BACKGROUND OF THE INVENTION

### 1. Field of the Invention

The present invention relates generally to fasteners for joining the edges of two generally planar members that are angularly offset from each other, and more particularly, to a fastener forming a hinged coupling between such planar members.

### 2. Description of the Related Art

Many products sold today make use of generally planar members that are joined together along their edges to form a three-dimensional structure. One example of such a three dimensional structure is the pet shelter shown in prior U.S. Pat. No. 9,326,483, issued to Hall on May 3, 2016. The pet shelter described in such patent includes a series of nestable modules, and each such module includes several generally vertical side walls joined at their adjacent side edges, along with an upper horizontal top wall. Various embodiments include modules that have four side walls which form a square or rectangular pattern, five side walls forming a pentagon, six side walls forming a hexagon, etc. In each case, adjacent edges of two side walls are joined to form a “corner” of the three-dimensional structure.

In order to minimize the space occupied by such products in shipment, it is desirable to package such products in a compact, disassembled form, with the flat panels lying parallel to each other within the package, until the product is assembled by the retailer and/or end user. However, this objective imposes several challenges, including a) minimizing difficulty of assembly of the packaged components, b) minimizing the cost of production, c) allowing for assembly of different numbers of flat panels to form different shapes; d) ensuring that the assembled three-dimensional product is relatively stable and will not easily fall apart; and e) providing for attachment of a top, horizontal wall that generally covers the space surrounded by the underlying flat panels. The pet shelter referenced above is but one example of a three-dimensional structure formed by attaching side edges of several planar members, and other applications will readily come to mind.

Accordingly, it is an object of the present invention to provide a corner bracket structure for joining adjacent side wall edges of generally planar members that are angularly offset from each other.

It is another object of the present invention to provide such a corner bracket structure which facilitates rapid and easy assembly of a three-dimensional product from generally planar members.

It is a further object of the present invention to provide such a corner bracket structure which is inexpensive to manufacture, lightweight, and easy to produce.

Still another object of the present invention is to provide such a corner bracket structure which is easily adjusted to vary the angle of offset between adjacent side wall panels.

A still further object of the present invention is to provide such a corner bracket structure which forms a stable and reliable attachment between two joined side wall panels following assembly.

Yet another object of the present invention is to provide such a corner bracket structure which facilitates attachment of an upper planar member that generally covers the joined side wall panels of the three-dimensional product.

These and other objects of the invention will become more apparent to those skilled in the art as the description of the present invention proceeds.

### SUMMARY OF THE INVENTION

Briefly described, and in accordance with a first preferred embodiment thereof, the present invention relates to a corner bracket structure, or fastening assembly, for fastening together a plurality of members. The corner bracket structure includes a first elongated member, sometimes referred to herein as an internal, or male, member, having at least one side edge. The side edge of the first elongated member includes two or more projections, each having a generally convex cross-section; in a preferred embodiment of the invention, these projections resemble barrels. These projections are longitudinally aligned with each other and spaced apart from each other by a first distance.

The corner bracket structure also includes a second elongated member, sometimes referred to herein as an external, or female, member, and also having at least one side edge. The side edge of the second elongated member includes an elongated channel or cavity having a generally concave cross-section. The elongated channel includes two or more retaining regions longitudinally aligned with each other, including at least a first retaining region adapted to retain a first projection of the first elongated member, and a second retaining region adapted to retain a second projection of the first elongated member. These first and second retaining regions are spaced apart from each other by a first recessed region adapted to receive the first projection of the first elongated member. Additional recessed regions may be provided between successive retaining regions for receiving a corresponding projection extending from the first elongated member; each of the recessed regions is longitudinally aligned with the retaining regions formed in the elongated channel of the second elongated member.

Preferably, the projections which extend from the first elongated member, and the retaining regions formed in the second elongated member are all of substantially equal length as each other. The recessed regions formed in the elongated channel of the second elongated member have a length that is at least as long as the length of projections extending from the first elongated member.

During assembly, the first elongated member is assembled to the second elongated member by inserting the first projection into the first recessed region; sliding the first elongated member relative to the second elongated member for sliding the first projection into the first retaining region, while simultaneously sliding the second projection into the second retaining region.

In the preferred embodiment, the first elongated member includes a generally flat plate for being secured to a first panel. Also, in the preferred embodiment, the second elongated member includes a generally flat plate for being secured to a second panel. Preferably, these flat plates each have a plurality of holes formed therein for receiving a corresponding plurality of fasteners for securing the generally flat plates to the first and second panels.

The projections of the first elongated member are longitudinally aligned with each other about a common longitudinal axis. The projections of the first elongated member and retaining regions of the second elongated member are preferably dimensioned in a manner which permits the second elongated member to rotate, relative to the first elongated member, through an angle of at least 40 degrees about such longitudinal axis after such projections are slidingly inserted into their respective retaining regions.

As mentioned above, it may be desired to secure a cover panel above the side wall panels. In one preferred embodiment of the present invention, a screw is adapted to be screwed into an end of the elongated channel of the second elongated member; this screw may pass through a cover that extends generally perpendicular to the elongated channel of the second elongated member. Such screw may serve the additional function of precluding or resisting further sliding and/or rotational motion of the projections relative to the retaining regions to prevent unintended disassembly of the adjacent side wall panels from each other.

### BRIEF DESCRIPTION OF THE DRAWINGS

FIG. 1 is a perspective view of a first elongated member including a series of spaced projections extending from a side edge thereof.

FIG. 2 is a top view of the first elongated member shown in FIG. 1.

FIG. 3 is a cross-sectional view of the first elongated member of FIG. 2 taken through section lines 3-3 in FIG. 2.

FIG. 4 is a perspective view of a second elongated member including an elongated channel, or cavity, formed along a side edge thereof.

FIG. 5 is a top view of the second elongated member shown in FIG. 4.

FIG. 6 is a cross-sectional view of the second elongated member of FIG. 5 taken through section lines 6-6 in FIG. 5.

FIGS. 7, 8 and 9 are a series of partial perspective drawings showing the assembly sequence for securing the internal member of one side panel wall to the external member of another side panel wall.

FIG. 10 is a perspective view of a hinged joint formed between two adjacent side panel walls following assembly in the manner indicated in FIGS. 7-9.

FIG. 11 is a top view of a hinged joint formed between two side panel walls and illustrating rotation of one side wall relative to the other adjacent side wall about the longitudinal axis of the hinged joint.

FIG. 12 is a perspective view of a pet shelter module formed by six side panel walls, arranged to form a hexagon, and including an upper cover plate secured thereto.

FIG. 13 is a perspective view of one of the six side panel walls used to form the structure shown in FIG. 12.

FIG. 14 is a close-up perspective view of a screw inserted into one end of the corner bracket structure for securing the first and second elongated members against further sliding or rotational motion.

FIG. 15 is a close-up perspective view of an upper corner of the pet shelter module shown in FIG. 12 including an upper cover panel overlying a corner formed between two adjacent side wall panels.

### DETAILED DESCRIPTION OF THE PREFERRED EMBODIMENTS

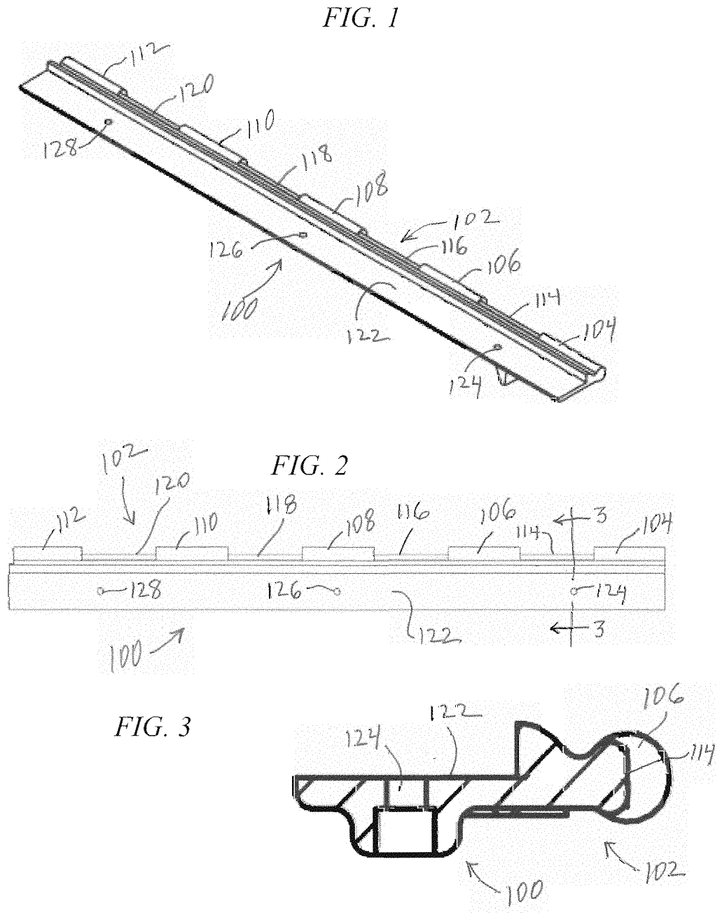

Referring to FIGS. 1-3, a first elongated member 100, also known as an internal member and/or male member, has a side edge 102 which includes a series of five cylindrical projections 104, 106, 108, 110, and 112. Each of such projections 104-112 has a generally convex cross-section, and such projections may also be referred to herein as barrels. Projections 104-112 are longitudinally aligned with each other and spaced apart from each other by spacing gaps 114, 116, 118, and 120. Preferably, each of projections 104-112 are of equal length, and each of spacing gaps 114-120 are of equal length. In the preferred embodiment, all of the projections 104-112 and all of the spacing gaps 114-120 all have a common length. First elongated member 100 also includes a generally flat plate 122 for being secured to a panel (not shown in FIGS. 1-3). Holes 124, 126 and 128 are formed in flat plate 122 for receiving fasteners, e.g., rivets or screws, for attaching flat plate 122 to a generally flat panel (not shown in FIGS. 1-3).

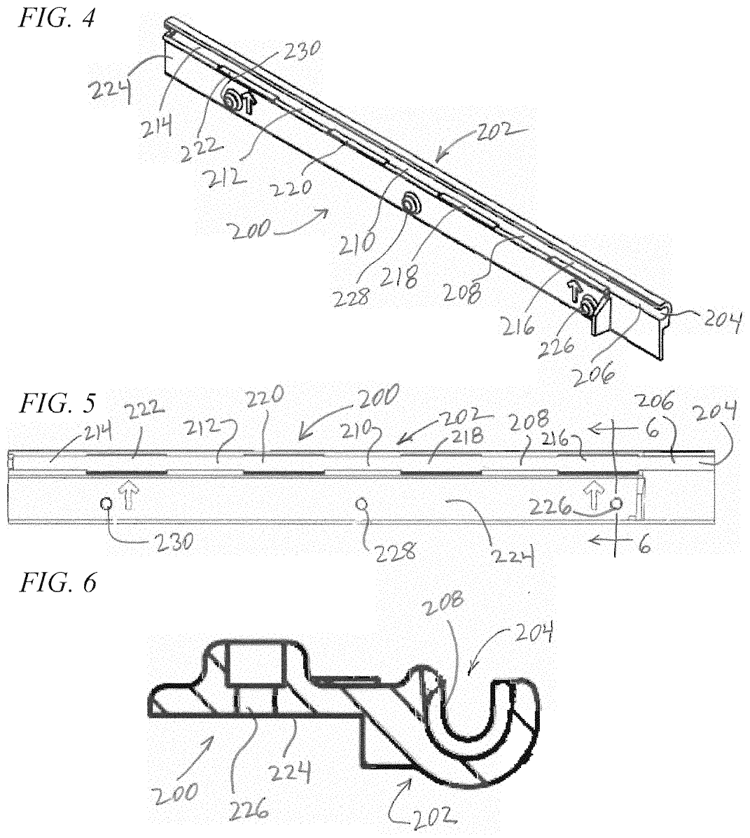

Referring now to FIGS. 4-6, a second elongated member 200, also known as an external member and/or female member, has a side edge 202 which includes an elongated channel 204 having a generally concave cross-section, sometimes referred to herein as a cavity. Elongated channel 204 includes a series of five retaining regions 206, 208, 210, 212, and 214 that are longitudinally aligned with each other. The first retaining region 204 is adapted to retain the first projection 104 on first elongated member 100. The second retaining region 208 is adapted to retain the second projection 106 on first elongated member 100, and so forth on down the line. Retaining regions 206-214 are spaced apart from each other by intervening recessed regions 216, 218, 220, and 222, respectively. Recessed regions 216-222 open more widely than retaining regions 206-214, and are adapted to receive projections 106-112. Application of light pressure to the first elongated member 100 will force projections 106-112 to snap into recessed regions 216-222 of second elongated member 200.

Recessed regions 216-222 are longitudinally aligned with retaining regions 206-214 for allowing projections 106-112 to slide from recessed regions 216-222 into retaining regions 208-214. Preferably, each of retaining regions 206-214 are of equal length, and each of recessed regions 216-222 are of equal length. In the preferred embodiment, all of the retaining regions 206-214 and all of the recessed regions 216-222 all have a common length equal to the length of the projections 104-112 of the first elongated member 100. Second elongated member 200 also includes a generally flat plate 224 for being secured to a panel (not shown in FIGS. 4-6). Holes 226, 228 and 230 are formed in flat plate 224 for receiving fasteners, e.g., rivets or screws, for attaching flat plate 224 to a generally flat panel (not shown in FIGS. 4-6).

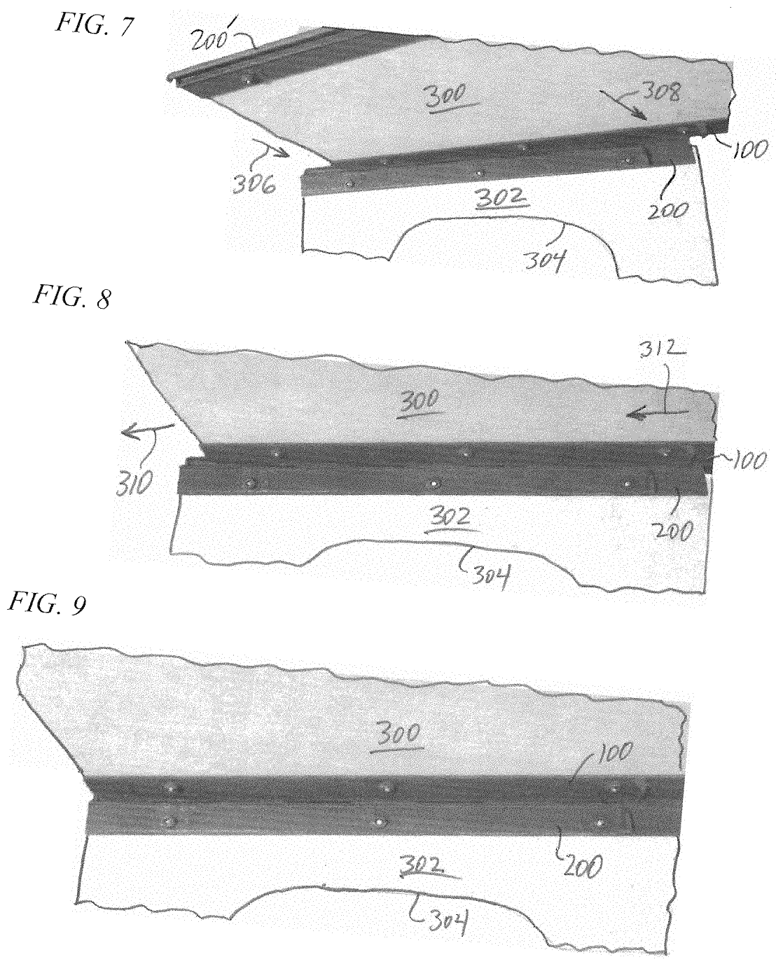

Turning to FIGS. 7-9, first elongated channel 100 is shown attached to a first side wall panel 300, and second elongated channel 200 is shown attached to a second side wall panel 302; side wall panel 302 has a hole 304 formed therein, in this case, to allow a cat or other pet to crawl therethrough. It will be noted that side wall panel 300 preferably includes another second elongated member 200′ attached to its opposing side, for being joined with yet another side wall panel. As shown in FIG. 7, side wall panel 300 is initially placed so that the projections extending from the side edge thereof are adjacent corresponding recessed regions of second elongated member 200. Panel 300 is then pushed inward, as indicated by arrows 306 and 308 to snap the projections of first elongated member 100 into corresponding recessed regions of second elongated member 200. Following the step illustrated in FIG. 7, side wall panel 300 is forced to the left, relative to side wall panel 302, for sliding first elongated member 100 relative to the second elongated member 200, thereby sliding the projections of first elongated member 100 into the corresponding retaining regions of second elongated member 200. This described sliding motion is indicated by arrows 310 and 312 in FIG. 8.

Finally, in FIG. 9, the sliding operation has been completed, and each of the projections extending from first elongated member 100 is fully-seated within its corresponding retaining region in second elongated member 200.

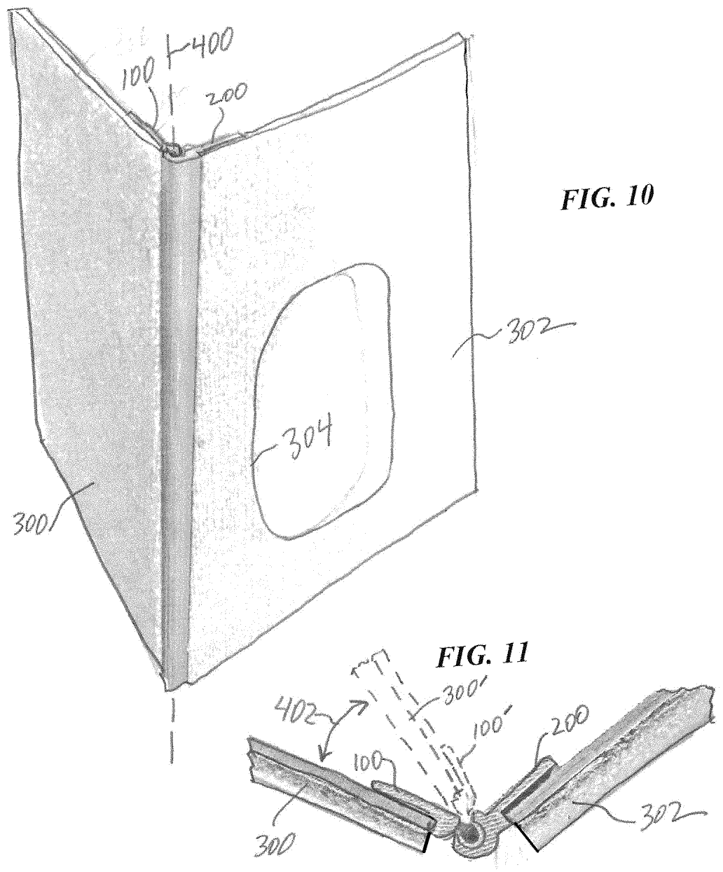

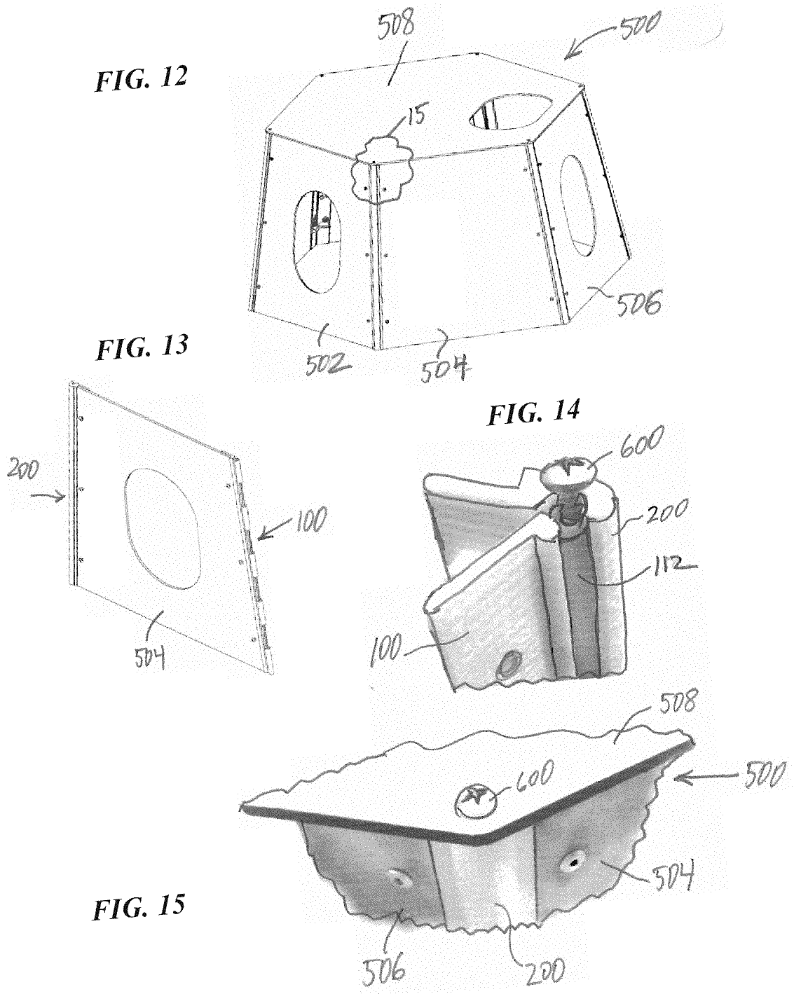

FIG. 10 shows the side wall panels 300 and 302 after assembly in the manner described in conjunction with FIGS. 7-9. While FIG. 10 shows side walls 300 and 302 forming a relatively square corner of about 90 degrees, side wall panels 300 and 302 are able to pivot relative to each other to a significant extent, thereby changing the relative angle formed by such side wall panels. In FIG. 10, longitudinal axis 400 is shown by dashed lines and indicates the axis about which side wall panels may rotate. Longitudinal axis 400 generally corresponds to the center of the projections, or barrels, extending from first elongated member 100. The series of projections 104-112 are retained within retaining regions 204-214, respectively, in a manner that allows the second elongated member 200 to rotate through an angle of at least 40 degrees about axis 400 relative to the first elongated member 100, or vice versa. In FIG. 11, side wall panel 300 is shown in solid lines extending approximately 120 degrees from side wall panel 302 in order to form a hexagon shape using six such panels, as indicated in FIG. 12. However, in FIG. 11, first elongated member 100′ and side wall panel 300′ are shown in dashed outline, rotated to an approximately 90 degree position to form a square shape with four such panels. Arrow 402 indicates that such angular relationship may be adjusted as desired. Thus, first elongated member 100 and second elongated member 200 provide a form of hinged connection between side wall panels 300 and 302. Those skilled in the art will appreciate that the projections 104-112 and retaining regions 204-214 may be modified, if desired, to reduce the angle formed between side wall panels 300 and 302 to zero, i.e., side wall panel 300 could be hinged to overlie side wall panel 302 to form a flattened, folded structure.

As already noted, FIG. 12 shows a structure 500 forming a hexagon shape including six side wall panels (including those designated 502, 504, and 506. Structure 500 further includes a top cover panel 508 secured to the upper portions of the side wall panels 502, 504 and 506. In FIG. 13, side wall panel 504 is shown having a first elongated member 100 riveted to one of its side edges, and a second elongated member 200 riveted to the opposite side edge. Six such panels can easily be attached edge-to-edge to form the base of structure 500.

Turning to FIG. 14, screw 600 is shown inserted into the upper end of elongated channel 200; preferably, screw 600 also threadedly engages an outermost projection, or barrel, of the first elongated member 100. Tightening screw 600 expands such barrel within its corresponding retaining region, thereby precluding or restricting further sliding motion and/or rotational motion as between first elongated member 100 and second elongated member 200, thereby locking side wall panels 300/302 (or 502/504/506) in place. It will be appreciated that, while screw 600 is illustrated in FIG. 14, alternate members, such as a push pin or dowel pin, might be used instead to lock the corner bracket structure in its desired final position.

FIG. 15 shows one corner of the hexagonal structure 500 along the upper portion of side wall panels 504 and 506. Top cover 508 cover extends generally perpendicular to the elongated channel of the second elongated member 200. Top cover 508 has a hole formed therein through which screw 600 has been inserted and threaded into the hinged corner bracket structure below. Screw 600 thereby serves to secure top cover panel 508 to underlying side wall panels 504 and 506, while also functioning to lock first elongated member 100 and second elongated member 200 in their desired hexagonal relationship. Once again, while screw 600 is shown, other fasteners, including a push pin or dowel pin, might be used instead.

Those skilled in the art will now appreciate that an advantageous corner bracket structure has been described for joining adjacent side wall edges of generally planar members that are angularly offset from each other. The disclosed corner bracket structure facilitates rapid and easy assembly of a three-dimensional product from generally planar members, and forms a stable and reliable attachment between two joined side wall panels following assembly. The first and second elongated members may be formed of a plastic material, e.g., nylon, and may be injection molded, or formed in another inexpensive manner. The disclosed corner bracket structure is inexpensive to manufacture, lightweight, and easy to produce, and facilitates packaging of three-dimensional products in a much more compact, unassembled form. Moreover, the corner bracket structure may be easily adjusted to vary the angle of offset between adjacent side wall panels to form structures of varying shapes; thus the same corner bracket structure may be used with products of differing shapes. In addition, a top cover panel can be easily attached to the underlying base formed the joined side wall panels.

While the present invention has been described with respect to preferred embodiments thereof, such description is for illustrative purposes only, and is not to be construed as limiting the scope of the invention. For example, while the preferred embodiment uses the novel corner bracket to join two side wall panels, those skilled in the art will appreciate that the disclosed corner bracket could also be used to join a side wall panel to a fixed wall, or some other fixed object. In addition, while the preferred embodiment describes the use of the novel corner bracket to join generally planar side wall panels, it will be appreciated that the disclosed hinged corner bracket could be used to join together two non-planar objects, if desired. Various modifications and changes may be made to the described embodiments by those skilled in the art without departing from the true spirit and scope of the invention as defined by the appended claims.

1. A fastening assembly for hingedly fastening together a plurality of members, comprising in combination:
a) a first elongated member having at least a side edge, the side edge of the first elongated member including at least first and second projections longitudinally aligned with each other and spaced apart from each other by a first distance, the first and second projections each having a generally convex cross-section;
b) a second elongated member having at least a side edge, the side edge of the second elongated member including an elongated channel having a generally concave cross-section, the elongated channel including at least first and second retaining regions longitudinally aligned with each other, the first retaining region being adapted to retain the first projection, and the second retaining region being adapted to retain the second projection, the first and second retaining regions being spaced apart from each other by a first recessed region adapted to receive the first projection,
c) wherein the first elongated member is assembled to the second elongated member by:
I) inserting the first projection into the first recessed region, and
II) sliding the first elongated member relative to the second elongated member for sliding the first projection into the first retaining region, and for simultaneously sliding the second projection into the second retaining region;
d) wherein the first projection and second projection are longitudinally aligned with each other about a common longitudinal axis, and wherein the first and second projections are retained within the first and second retaining regions, respectively, in a manner that allows the second elongated member to rotate, relative to the first elongated member through an angle of approximately 10 to 40 degrees about the common longitudinal axis.

2. The fastening assembly recited by claim 1 wherein the first elongated member includes a generally flat plate for being secured to a panel.

3. The fastening assembly recited by claim 2 wherein the generally flat plate has a plurality of holes formed therein for receiving a corresponding plurality of fasteners for securing the generally flat plate to the panel.

4. The fastening assembly recited by claim 1 wherein the second elongated member includes a generally flat plate for being secured to a panel.

5. The fastening assembly recited by claim 4 wherein the generally flat plate has a plurality of holes formed therein for receiving a corresponding plurality of fasteners for securing the generally flat plate to the panel.

6. The fastening assembly recited by claim 1 wherein the first elongated member includes a first generally flat plate for being secured to a first panel, and the second elongated member includes a second generally flat plate for being secured to a second panel.

7. The fastening assembly recited by claim 6 wherein the first generally flat plate has a first plurality of holes formed therein for receiving a first corresponding plurality of fasteners for securing the first generally flat plate to the first panel, and the second generally flat plate has a second plurality of holes formed therein for receiving a second corresponding plurality of fasteners for securing the second generally flat plate to the second panel.

8. The fastening assembly recited by claim 1 wherein the first projection has a first length, wherein the second projection has a second length, wherein the first retaining region has a third length, and the second retaining region has a fourth length, and the first length, second length, third length, and fourth length are substantially equal to each other.

9. The fastening assembly recited by claim 8 wherein the first recessed region has a fifth length, and wherein said fifth length is substantially equal to the first length, second length, third length, and fourth length.

10. The fastening assembly recited by claim 1 wherein the elongated channel includes a second recessed region adapted to receive the second projection, the second recessed region being longitudinally aligned with the first and second retaining regions and with the first recessed region, the first and second recessed regions being disposed on opposite sides of the second retaining region, and wherein, during assembly of the first elongated member to the second elongated member, the second projection is inserted into the second recessed region, and the second projection thereafter slides from the second recessed region into the second retaining region.

11. (canceled)

12. The fastening assembly recited by claim 1 further including a screw adapted to be screwed into an end of the elongated channel of the second elongated member.

13. The fastening assembly recited by claim 12 wherein said screw enters into at least one projection of the first elongated member.

14. The fastening assembly recited by claim 12 wherein said screw is adapted to be inserted through a cover that extends generally perpendicular to the elongated channel of the second elongated member.
